(19) United States
(12) Patent Application Publication
(10) Pub. No.: US 2003/0037634 A1
(43) Pub. Date: Feb. 27, 2003

(54) Steering wheel overlay kit

(76) Inventor: Erin Ward, Oakland, CA (US)

Correspondence Address: Don E. Erickson, PMB 182, 3830 Valley Center Dr., #705, San Diego, CA, 92130, US

(21) Appl. No.: 09/935,944

(22) Filed: Aug. 24, 2001

(51) Int. Cl. B62D 1/06

(52) U.S. Cl. 74/558; 74/552

(57) ABSTRACT

An overlay kit for enhancing the appearance of a steering wheel assembly in a vehicle, the steering wheel assembly having a circumferential, ring-shaped grip, a center pad having a peripheral surface, and a plurality of generally radially inwardly extending spokes connecting the circumferential grip and the center pad. The overlay kit is shaped to cover two opposing portions of the ring-shaped grip, and includes a set of first and second complementary arcuate half shell, each half shell in the shape of a half cylinder having two longitudinal rims and two semicircular rims sized to approximate the outside diameter of the cross-section of the ring-shaped grip. The longitudinal rims of the first complementary half shell have a complementary surface to mate with the longitudinal rim of the second complementary half shell. When the first complementary half shell is placed about the ring-shaped grip and the second complementary half shell is placed about the opposite side of the ring-shaped grip, the complementary half shells bindingly adhere to the ring-shaped grip to form the overlay.

### FIELD OF THE INVENTION

The present invention relates generally to covers for automobile and truck steering wheels, and more particularly to an overlay kit for enhancing the looks of the steering wheel, the overlay covering portions the grip of the steering wheel.

### BACKGROUND OF THE INVENTION

Various kinds of “after market” steering wheel covers are available for improving the appearance, grip and comfort of existing or original equipment steering wheels. These after market steering wheel covers are typically sold through retail supply outlets and do not require any particular expertise to install and therefore can be installed by the vehicle owner. Such covers provide a relatively simple and inexpensive way to improve looks and beauty of the steering wheel without having to remove and replace it with a custom wheel. In fact, with the advent of complex airbag safety systems in which the airbag is enclosed within a housing or module under the center pad of the steering wheel, the removal of the steering wheel by unqualified persons is discouraged by original equipment automobile and truck manufacturers.

Attempts have been made to provide adhesively bonded steering wheel covers that do not cover the finger indentations on the back of the steering wheel grip but these are not altogether satisfactory. Since these partial steering wheel covers only cover a portion of the grip and since the area of the bonded surface is limited, these covers tend to peel off, and particularly so when subjected to the twisting forces often applied to the steering wheel grip by the driver.

One attempt to overcome such problems is U.S. Pat. No. 5,761,968 to Poteet, which discloses a steering wheel “after-market” overlay. The overlay of Poteet has a unitary, integral, relatively stiff, thin-walled construction of generally semicircular cross-section, and is adhesively applied to the surface of the upper portion of an original equipment steering wheel. The overlay covers the upper portion of the steering wheel grip and the upper portions of the steering wheel spokes up to the center pad of the steering wheel. However, the overlay of Poteet suffers the same problems as some of the prior art it was intended to replace. The “feathered periphery may separate and chip from the surface of the steering wheel, creating an erose surface which may abrade the fingers of the driver. If the overlay does not adhere firmly to the steering wheel, the overlay may separate from the steering wheel, and create a problem for the driver.

Leather or vinyl steering wheel straps wrapped around the rim or grip of the steering wheel are well known. These after-market steering wheel enhancements, however, do not provide sufficient versatility as to surface textures and they also do not conform closely enough to the surface of the steering wheel grip. Moreover, they cover the finger indentations on the back surface of the steering wheel grip.

### SUMMARY OF THE INVENTION

The present invention provides a simple, inexpensive and easily installable overlay for improving the appearance, comfort and grip of a steering wheel assembly without having to remove the assembly. The overlay of the present invention encapsulates portions of the steering wheel grip, provides a wood grained appearance, and is not subject to peeling or displacement relative to the wheel.

In accordance with the present invention, there is provided a steering wheel after-market overlay that has a pair of complementary sets of cylindrically arcuate tubes of relatively stiff, thin-walled construction of wood grained appearance. The complementary sets are adapted to be adhesively applied to and closely conform to the original equipment steering wheel and completely encapsulates both the upper and lower portions of the steering wheel between the spokes. By encapsulating the total tubular surface area of the steering wheel portions, not only is the appearance of the overlaid steering wheel enhanced, but the bonded surface area is also substantially increased thereby assuring the long term positional stability and peel resistance of the overlay. Furthermore, by providing a complementary set of overlays that matingly join at their common interface, the overlay feels smooth to the touch of the driver.

The overlay of the present invention may be made of many different materials and can provide a range of textures and surface treatments. For example, without limitation, the overlay can be formed of acrylic plastic, carbon fiber or fiberglass and can be made to simulate wood, leather or vinyl. The overlay can be covered with various materials such as leather or vinyl. Moreover, the overlay of the invention may be applied to the steering wheels of new or used vehicles , the overlay may be used with any kind of steering wheel.

### BRIEF DESCRIPTION OF THE DRAWINGS

Further objects, advantages and features of the present invention will become apparent from the detailed description, below, when read in conjunction with the accompanying drawings in which:

FIG. 1 is a plan view of an original equipment steering wheel assembly showing the main features thereof;

FIG. 2 is a section view taken along the line 2-2 in FIG. 1;

FIG. 3 is a perspective view of an overlay in accordance with the present invention;

FIG. 4 is a section view taken along the line 4-4 in FIG. 3; and

FIG. 5 is a perspective view of a partial original equipment steering wheel assembly with overlays of the present invention installed thereon.

### DETAILED DESCRIPTION OF THE PREFERRED EMBODIMENT

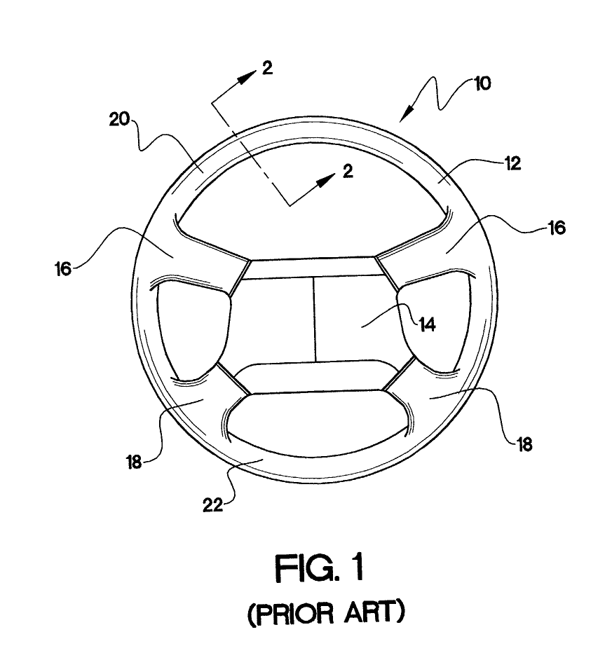

FIG. 1 shows a typical original equipment steering wheel assembly 10 to which the overlay of the present invention may be applied. As is well known, the steering wheel assembly 10 includes a circumferential, unitary ring-like rim or grip 12, a center pad 14 and an upper pair of generally radially inwardly extending spokes 16 connecting the grip 12, a lower pair of generally radially inwardly extending spokes 18, an upper hand grip portion 20, and a lower hand grip portion 22. Upper hand grip portion 20 traverses the distance between upper spokes 16, and lower hand grip portion 22 traverses the distance between lower spokes 18. In the example shown, the steering wheel assembly 10 has four spokes (16, 18) although it will be understood that the number of spokes will depend upon the particular steering wheel assembly design. The present invention is independent of the type of steering wheel, the existence of a supplemental restraint system in the form of an airbag module, and whether or not the steering wheel assembly is dished, that is, the center pad 14 is below the plane of the ring-like grip 12.

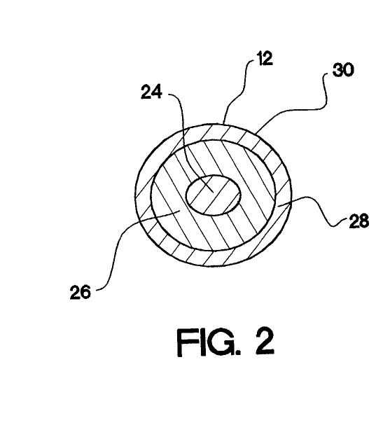

As best seen in FIG. 2, the grip 12 of the steering wheel assembly 10, having outer surface 30, is constructed around a metallic core 24 (details of which are well-known in the art). Core 24 may be encased within foam or like resilient material 26 in turn covered by a flexible cover material 28 such as leather or vinyl. Thus, both upper hand grip portion 20 and lower hand grip portion 22 form generally arcuate solid cylinders.

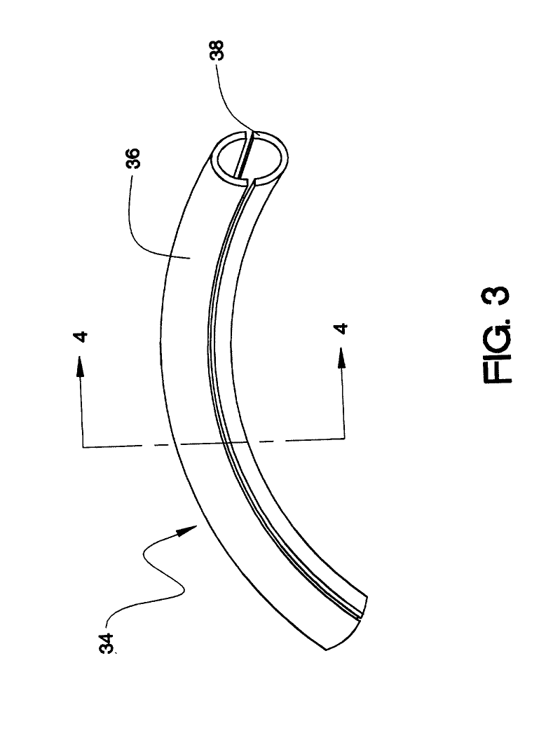

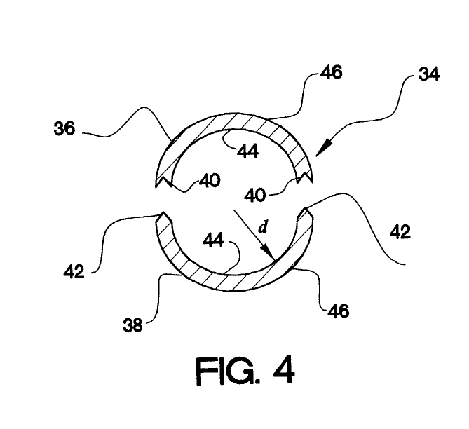

FIG. 3 shows an exemplary embodiment of a two-part, arcuate, hollow cylindrical steering wheel overlay in accordance with the invention. The overlay 34 is comprised of two complementary half shells 36 and 38. FIG. 4 shows a cross-section of overlay 34, with complementary semi-circular half-shells 36 and 38, having complementary mating interfaces 40 and 42 respectively, and interior surfaces 44. When complementary half-shells 36 and 38 are joined to form a cylinder, the interior diameter d of such overlay is selected to be equal to the outside diameter of grip 12, such that when overlay 34 is placed about grip 12, the inner surface 44 abuts outer surface 30 of grip 12. Complementary surfaces 40 and 42 may be of any configuration that permits smooth joining of the two halves, such as tongue and groove, mortise and tenon, or any other joint that permits of dovetailing the two complementary halves. The arcuate length of overlay 34 is selected to substantially traverse the distance between upper spokes 16 and/or lower spokes 18, it being recognized that the only difference between the lengths of the overlays may be the different distances between the spokes, and that the only difference between an overlay for an upper grip portion and an overlay for a lower grip portion may be such traverse distance. It should also be recognized that the external diameters for grip 12 for various makes and models of vehicles may vary, and that overlay 34 need be sized accordingly in order to effect a proper fit.

Each complementary half shell 36 and 38 is a unitary, integral, relatively stiff, thin-walled structure which, when made of plastic, may be readily molded or vacuum formed as a single piece by well-known fabrication techniques. By “relatively” stiff is meant that the overlay 34 has a limited amount of flexibility to permit the overlay to be pressed into conformity with the receiving surface 30 of the steering wheel assembly, as will be described below. The overlay may be made of an acrylic plastic, carbon fiber or fiberglass or the like, but may also be made of wood, metal, rubber or the like. In accordance with one practical form of the invention, overlay 34 is made of an acrylic plastic about 0.040 to about 0.080 inches thick. The exterior surface 46 may be provided with various textures, patterns, or other finishes. A design may be embedded within the material itself or, where clear acrylic plastic is used for the overlay material, simulated wood, carbon fiber or other patterns can be screen printed on, or otherwise applied to, the interior surface 44. The exterior surface 46 can be treated likewise or covered with various grip and appearance enhancing materials such as leather or vinyl.

The distal ends of overlay 34 may be feathered so as to enhance the appearance of the overlaid steering wheel assembly without detracting from its comfort.

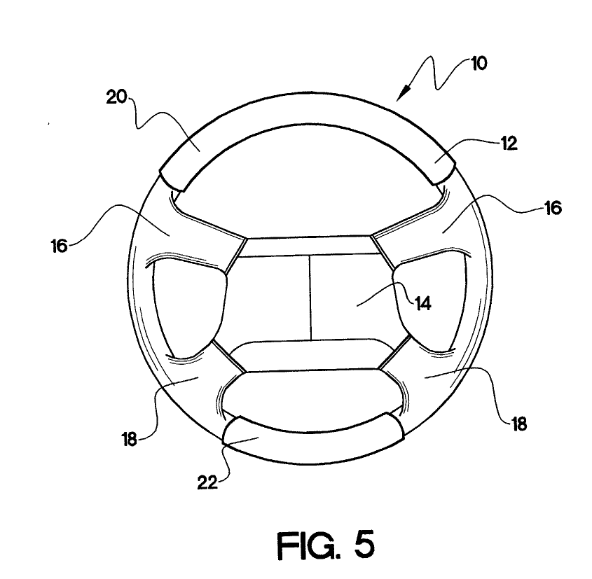

The installed overlay is shown in FIG. 5. The exterior surface 30 of grip portion 20 and/or grip portion 22 are cleaned with an appropriate solvent and the overlay is adhesively applied to the steering wheel. For this purpose, the interior surfaces 44 of the overlay are preferably provided with adhesive tape from which a protective film is peeled before applying the overlay to the grip portion of the steering wheel. Alternatively, the interior surface of the overlay may be coated with an adhesive-bonding agent furnished with the overlay. The combined overlay surface area that is bonded to the steering wheel is large enough to insure that the overlay will be held in place and will not peel off the steering wheel. Alternatively, the adhesive could be applied to complementary mating surfaces 40 and 42. The method of adhesive bonding the overlay to the grip portion is not limited to the methods described above. The overlay may be attached to the grip portion by any means known to one of ordinary skill in the art. For example, the grips could adhere to the exterior surface 30 by means of a leather strap wrapped around the external surface of the complementary half shells firmly affixing the complementary half shells to the exterior surface 30. In this sense, “adhered to” can be read to additionally mean “affixed to.”

While preferred embodiments of the present invention have been disclosed herein, it will be obvious that they may be varied in many ways. Such variations are not to be regarded as a departure from the spirit and scope of the invention, and all such modifications as would be obvious to those skilled in the art are intended to be included within the scope of the claims that follow.

I claim:

1. An overlay kit for enhancing the appearance of a steering wheel assembly in a vehicle, the steering wheel assembly having a circumferential, ring-shaped grip, a center pad having a peripheral surface, and a plurality of generally radially inwardly extending spokes connecting the circumferential grip and the center pad, the overlay kit being shaped to cover portions of the ring-shaped grip, the overlay kit comprising:
at least one set of first and second complementary arcuate half shells, each half shell in the shape of a half cylinder having two longitudinal rims, two semicircular rims and an internal surface defined therebetween, each half shell having a selected internal cross-sectional diameter, each half shell sized along its longitudinal axis to span the distance between two adjacent spokes of the ring-shaped grip, the longitudinal rims of the first complementary half shell having a surface to mate with the longitudinal rims of the second complementary half shell, each complementary half shell having means to adhere to the ring-shaped grip; and
whereby, when the first complementary half shell is placed about the ring-shaped grip and the second complementary half shell is placed about the opposite side of the ring-shaped grip, the complementary half shells bindingly adhere to the ring-shaped grip to form an overlay.

2. The overlay kit of claim 1 additionally comprising a second set of first and second complementary arcuate half shells, the second set of half shells sized to span the distance between two adjacent spans of the ring-shaped grip of the steering wheel opposite the first set, the second set of complementary half shells constructed essentially identical to the overlay of claim 1.

3. The overlay kit of claim 1 wherein the mating surfaces of the longitudinal rims of the first complementary half shell is formed in the shape of a tongue and the mating surfaces of the longitudinal rims of the second complementary half shell is formed in the shape of a groove.

4. The overlay kit of claim 1 wherein the mating surfaces of the longitudinal rims of the first complementary half shell is formed in the shape of a mortise and the mating surfaces of the longitudinal rims of the second complementary half shell is formed in the shape of a tenon.

5. The overlay kit of claim 1 wherein the selected internal cross-sectional diameter of the first and second complementary half shells approximates the outside diameter of the external cross-section of the ring-shaped grip.

6. The overlay kit of claim 1 wherein the two semicircular rims of the first and second complementary half shells is feathered to provide a smooth surface from the outer surface of the overlay to the surface of the ring-shaped grip.

7. The overlay kit of claim 1 wherein the set of first and second complementary half shells is constructed from the group of acrylic plastic, carbon fiber, fiberglass, wood, metal, or rubber.

8. The overlay kit of claim 1 wherein the set of first and second complementary half shells has a selected thickness, the thickness 0.040 to about 0.080 inches for acrylic plastic.

9. The overlay kit of claim 1 wherein the means to adhere to the ring-shaped grip comprises an adhesive bonding agent applied between the internal surfaces of the first and second complementary half shells and the external surface of the ring-shaped grip.

10. The overlay kit of claim 1 wherein the means to adhere the overlay to the ring-shaped grip comprises an adhesive bonding agent applied to the longitudinal rims of the first and second complementary half shells.

11. An overlay kit for enhancing the appearance of a steering wheel assembly in a vehicle, the steering wheel assembly having a circumferential, ring-shaped grip, a center pad having a peripheral surface, and a plurality of generally radially inwardly extending spokes connecting the circumferential grip and the center pad, the overlay kit being shaped to cover portions of the ring-shaped grip, the overlay kit comprising:
at least one set of first and second complementary arcuate half shells, each half shell in the shape of a half cylinder having two longitudinal rims, two semicircular rims and an internal surface defined therebetween;
each half shell having a selected internal cross-sectional diameter, the selected internal cross-sectional diameter of the first and second complementary half shells sized to approximate the outside diameter of the cross-section of the ring-shaped grip;
each half shell sized along its longitudinal axis to span the distance between two adjacent spokes of the ring-shaped grip, the longitudinal rims of the first complementary half shell having a surface to mate with the longitudinal rims of the second complementary half shell;
each complementary half shell having means to adhere to the ring-shaped grip, the two semicircular rims of the first and second complementary half shells feathered to provide a smooth surface from the outer surface of the overlay to the surface of the ring-shaped grip; and
whereby, when the first complementary half shell is placed about the ring-shaped grip and the second complementary half shell is placed about the opposite side of the ring-shaped grip, the complementary half shells bindingly adhere to the ring-shaped grip to form an overlay.

12. The overlay kit of claim 11 additionally comprising a second set of first and second complementary arcuate half shells, the second set of half shells sized to span the distance between two adjacent spans of the ring-shaped grip of the steering wheel opposite the first set, the second set of complementary half shells constructed essentially identical to the overlay of claim 11.

13. The overlay kit of claim 11 wherein the mating surfaces of the longitudinal rims of the first complementary half shell is formed in the shape of a tongue and the mating surfaces of the longitudinal rims of the second complementary half shell is formed in the shape of a groove.

14. The overlay kit of claim 11 wherein the mating surfaces of the longitudinal rims of the first complementary half shell is formed in the shape of a mortise and the mating surfaces of the longitudinal rims of the second complementary half shell is formed in the shape of a tenon.

15. The overlay kit of claim 11 wherein the two semicircular rims of the first and second complementary half shells is feathered to provide a smooth surface from the outer surface of the overlay to the surface of the ring-shaped grip.

16. The overlay kit of claim 11 wherein the set of first and second complementary half shells is constructed from the group of acrylic plastic, carbon fiber, fiberglass, wood, metal, or rubber.

17. The overlay kit of claim 11 wherein the set of first and second complementary half shells has a selected thickness, the thickness 0.040 to about 0.080 inches for acrylic plastic.

18. The overlay kit of claim 11 wherein the means to adhere to the ring-shaped grip comprises an adhesive bonding agent applied between the internal surfaces of the first and second complementary half shells and the external surface of the ring-shaped grip.

19. The overlay kit of claim 1 wherein the means to adhere the overlay to the ring-shaped grip comprises an adhesive bonding agent applied to the longitudinal rims of the first and second complementary half shells.
